(19) United States
(12) Patent Application Publication
(10) Pub. No.: US 2024/0400758 A1
(43) Pub. Date: Dec. 5, 2024

(54) ADHESIVE COMPOSITION BASED ON CROSSLINKABLE SILYLATED POLYMER

(71) Applicants: Bostik SA, COLOMBES (FR); Centre National De La Recherche Scientifique, PARIS (FR); Universite de Bordeaux, BORDEAUX (FR); Institut Polytechnique de Bordeaux, TALENCE (FR)

(72) Inventors: Boris COLIN, VENETTE (FR); Frédéric SIMON, VENETTE (FR); Stéphane FOUQUAY, Mont Saint Aignan (FR); Guillaume MICHAUD, GENAY (FR); Mathieu PUCHEAULT, TALENCE CEDEX (FR); Laurent CHABAUD, FLOIRAC (FR)

(21) Appl. No.: 18/699,952

(22) PCT Filed: Oct. 18, 2022
(86) PCT No.: PCT/FR2022/051967

§ 371 Date: Apr. 10, 2024

(30) Foreign Application Priority Data
Oct. 21, 2021 (FR) FR2111162

(51) Int. Cl. C08G 65/336; C07F 5/02; C09D 171/02; C09J 171/02

(52) U.S. Cl. CPC C08G 65/336; C07F 5/027; C09D 171/02; C09J 171/02

(57) ABSTRACT

An adhesive composition comprises a silylated polymer (A) comprising a group of formula (I) and a catalyst (B) of formula (V). In formula (I): —Si(R⁴)ₚ(OR⁵)₃₋ₚ, each R⁴ independently represents a linear or branched alkyl radical comprising from 1 to 4 carbon atoms; each R⁵ independently represents a linear or branched alkyl radical comprising from 1 to 10 carbon atoms and optionally comprising one or more heteroatoms chosen from oxygen and nitrogen, or two OR⁵ groups are involved in the same ring comprising from 2 to 8 carbon atoms; p is an integer equal to 0, 1 or 2. In formula (V): B(OH)R′R″, R′ represents a substituted or unsubstituted aryl group; and R″ is chosen from an OH group and a substituted or unsubstituted aryl group.

### FIELD OF THE INVENTION

The present invention relates to an adhesive composition comprising a silylated polymer and a catalyst and also to the use of this composition as adhesive or coating. The present invention also relates to an article comprising a layer obtained by crosslinking of said composition and to a process for the preparation of said article.

### TECHNICAL BACKGROUND

Silylated polymers can be used in various types of applications, for example in adhesive compositions which can be used for all types of adhesive bonding, such as the adhesive bonding of surface coatings, or also which can be used to form a leaktightness membrane or also to prepare self-adhesive articles.

Silylated polymers can be crosslinked, even at ambient temperature, by reaction of the reactive silyl group with atmospheric moisture. In order to accelerate the crosslinking of the silylated polymer, it is possible to add a crosslinking catalyst to the silylated polymer.

Generally, the crosslinking catalyst used in adhesive compositions based on silylated polymers is a tin-based catalyst, such as dibutyltin dilaurate (DBTDL), dibutyltin diacetate, dibutyltin bis(acetylacetonate) or also dioctyltin.

However, the toxicity of these tin-based catalysts is increasingly being highlighted, which is leading manufacturers to avoid their use.

Tin-free catalysts have been developed for the crosslinking of silylated polymers, among which may be mentioned bismuth neodecanoate or zinc octoate or neodecanoate. These tin-free catalysts are 2 to 3 times less effective than tin-based catalysts. Thus, in order to obtain crosslinking times equivalent to those obtained with tin-based catalysts, it will be necessary to introduce 2 to 3 times more catalyst of bismuth neodecanoate or zinc octoate type.

The catalysis of silylated polymers via organic catalysts is also possible via the intermediary of 1,8-diazabicyclo[5.4.0]undec-7-ene (DBU) or 1,5,7-triazabicyclo[4.4.0]dec-5-ene (TBD) but these have the disadvantage of causing a yellow coloring in the finished products due to the migration of the catalyst into the surface of the mastic, limiting their use in a good deal of industrial products.

The crosslinking catalyst must make it possible to accelerate the crosslinking of the silylated polymer during its use. It must also remain stable during the storage of the adhesive composition before use; in other words, it must retain its ability to accelerate the crosslinking of said polymer, after the storage of the adhesive composition up to its use by the end user.

In addition, for optimum use of the adhesive composition, said adhesive composition must not crosslink during its storage.

The paper by Nomura Y. et al. (Curing of Silylated Polyurethane with BF₃-Monoethylamine Complex as Moisture-Curable Adhesives and Their Properties, Journal of Applied Polymer Science, 106 (2007), 3165-3170) describes the use of BF₃ in combination with a monoethylamine for the crosslinking of silylated polyurethanes.

The paper by Huber P. et al. (FTIR Investigations on Hydrolysis and Condensation Reactions of Alkoxysilane Terminated Polymers for Use in Adhesives and Sealants, Int. J. of Adhesion & Adhesives, 64 (2016), 153-162) also describes the use of BF₃ in combination with a monoethylamine for the crosslinking for hydrolysis and condensation reactions of alkoxysilane-terminated polymers.

The paper by Adachi K. et al. (Accelerated Silane Water-Crosslinking Kinetics of Ethylene-Propylene Copolymer by Boron Trifluoride Complexes, Macromol. React. Eng., 1 (2007), 313-320) relates to the use of BF₃ complexes for the crosslinking of ethylene-propylene copolymers having grafted vinyltrimethoxysilane groups.

The document EP 2 267 083 relates to a curable composition devoid of tin catalyst, comprising an organic polymer having a silicon-containing group crosslinkable by formation of a siloxane bond (reactive silyl group), a guanidine compound and a compound containing a methyl ester group.

The document U.S. Pat. No. 8,124,690 relates to a moisture-curable polymer, the polymer having a silicon group.

There thus exists a real need to provide a crosslinkable adhesive composition devoid of tin exhibiting a rapid crosslinking time and good stability (in particular during storage).

### SUMMARY OF THE INVENTION

The invention relates firstly to an adhesive composition comprising:
at least one silylated polymer (A) comprising at least one group, preferably at least two groups, of formula (I):

—Si(R⁴)ₚ(OR⁵)₃₋ₚ (I)
in which:
   each R⁴ independently represents a linear or branched alkyl radical comprising from 1 to 4 carbon atoms;
   each R⁵ independently represents a linear or branched alkyl radical comprising from 1 to 10 carbon atoms and optionally comprising one or more heteroatoms chosen from oxygen and nitrogen, or two OR⁵ groups are involved in one and the same ring comprising from 2 to 8 carbon atoms;
   p is an integer equal to 0, 1 or 2;
and at least one catalyst (B) of formula (V):

B(OH)R′R″ (V)
in which:
   R′ represents a substituted or unsubstituted aryl group; and
   R″ is chosen from an OH group and a substituted or unsubstituted aryl group.

According to some embodiments, the catalyst (B) has one of the following formulae:

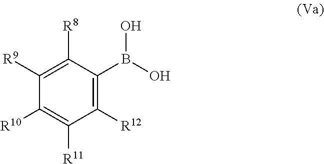

in which R⁸, R⁹, R¹⁰, R¹¹ and R¹² represent, independently of one another, a hydrogen atom, a halogen atom or a linear or branched alkyl group comprising from 1 to 20 carbon atoms and which can comprise at least one heteroatom;

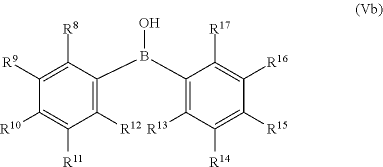

in which:
   R⁸, R⁹, R¹⁰, R¹¹ and R¹² are as described in detail above; and
   R¹³, R¹⁴, R¹⁵, R¹⁶ and R¹⁷ represent, independently of one another, a hydrogen atom, a halogen atom or a linear or branched alkyl group comprising from 1 to 20 carbon atoms and which can comprise at least one heteroatom; and

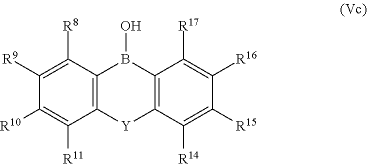

in which:
   R⁸, R⁹, R¹⁰, R¹¹, R¹², R¹³, R¹⁴, R¹⁵, R¹⁶ and R¹⁷ are as described in detail above; and
   Y is an oxygen or sulfur atom.

According to some embodiments, R⁸, R⁹, R¹⁰, R¹¹, R¹², R¹³, R¹⁴, R¹⁵, R¹⁶ and R¹⁷ are chosen from a hydrogen atom, a linear or branched alkyl group comprising from 1 to 20 carbon atoms, preferably from 1 to 5 carbon atoms, a linear or branched fluoroalkyl group comprising from 1 to 20 carbon atoms and preferably from 1 to 5 carbon atoms, a cycloalkyl group comprising from 1 to 20 carbon atoms and preferably from 1 to 5 carbon atoms, and a halogen, and preferably are chosen from a fluoroalkyl group, preferably a —CF₃ group, a halogen, and also their combinations.

According to some embodiments, one, preferably two and more preferably three of the R⁸, R⁹, R¹⁰, R¹¹, R¹², R¹³, R¹⁴, R¹⁵, R¹⁶ and R¹⁷ groups are chosen from a fluorine atom and a fluoroalkyl group comprising from 1 to 20 carbon atoms, preferably from 1 to 5 carbon atoms and more preferably a —CF₃ group.

In some embodiments, the composition is a one-component composition or a two-component composition.

According to some embodiments, the catalyst is present at a content of from 0.05% to 10% by weight and preferably from 0.5% to 5% by weight, with respect to the total weight of the silylated polymer.

According to some embodiments, the silylated polymer corresponds to one of the formulae (II), (III) or (IV):

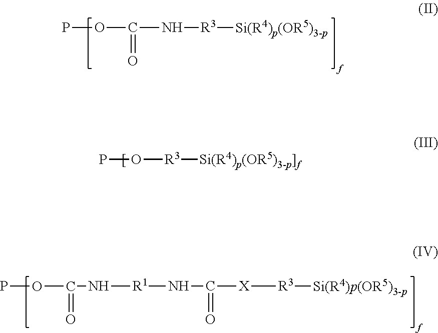

in which:
   P represents a saturated or unsaturated, linear or branched, polymeric radical optionally comprising one or more heteroatoms, such as oxygen, nitrogen, sulfur or silicon,
   R¹ represents a divalent hydrocarbon radical comprising from 5 to 15 carbon atoms which can be aromatic or linear or branched aliphatic, or cycloaliphatic,
   R³ represents a linear or branched divalent alkylene radical comprising from 1 to 6 carbon atoms,
   X represents a divalent radical chosen from —NH—, —NR⁷—, —O— or —S—,
   R⁷ represents a linear or branched alkyl radical comprising from 1 to 20 carbon atoms and which can also comprise one or more heteroatoms,
   f is an integer ranging from 1 to 6.

The invention also relates to the use of the composition described above as adhesive for bonding two substrates together, or as coating on the surface of a substrate.

The invention also relates to an article comprising at least one layer obtained by crosslinking of the composition described above, the layer preferably being a layer of adhesive.

The invention also relates to a process for the preparation of the article described above, comprising the application of the adhesive composition to a surface, followed by the crosslinking of said adhesive composition.

The invention also relates to the use of a compound of formula (V):

B(OH)R′R″ (V)
in which:
   R′ represents a substituted or unsubstituted aryl group; and
   R″ is chosen from an OH group and a substituted or unsubstituted aryl group,
for catalyzing the crosslinking of a silylated polymer (A) comprising at least one group, preferably at least two groups, of formula (I):

—Si(R⁴)ₚ(OR⁵)₃₋ₚ (I)
in which:
   each R⁴ independently represents a linear or branched alkyl radical comprising from 1 to 4 carbon atoms;
   each R⁵ independently represents a linear or branched alkyl radical comprising from 1 to 10 carbon atoms and optionally comprising one or more heteroatoms chosen from oxygen and nitrogen, or two OR⁵ groups will be involved in one and the same ring comprising from 2 to 8 carbon atoms; and
   p is an integer equal to 0, 1 or 2.

In particular, the compound of formula (V) is used to catalyze the crosslinking of said silylated polymer (A) by condensation of hydrolyzed alkoxysilane (silanol) groups to form siloxane (—Si—O—Si—) bonds.

According to some embodiments, the catalyst (B) is as described above or in the detailed description (including the embodiments and the preferred characteristics), and/or the silylated polymer (A) is as described above or in the detailed description (including the embodiments and the preferred characteristics).

The present invention makes it possible to meet the need expressed above. It more particularly provides a crosslinkable adhesive composition which can be devoid of tin and which exhibits a rapid crosslinking time and good stability (in particular during storage).

This is accomplished by virtue of the composition according to the invention. More particularly, the compound of formula (V) acts efficiently as catalyst for crosslinking the silylated polymer, in particular by condensation of hydrolyzed alkoxysilane (silanol) groups to form siloxane (—Si—O—Si—) bonds. This makes it possible to avoid catalysts comprising tin and also catalysts exhibiting stability problems (such as the coloration of the final product). In addition, the catalyst of formula (V) efficiently crosslinks the silylated polymer at times and amounts similar to those of the tin catalysts.

### DETAILED DESCRIPTION

The invention is now described in more detail and in a nonlimiting way in the description which follows.

The invention relates to an adhesive composition comprising a silylated polymer (A) and a catalyst (B).

### Silylated Polymer (A)

Within the meaning of the present invention, the term “silylated polymer” is understood to mean a polymer comprising at least one alkoxysilane group. Preferably, the silylated polymer comprising at least one alkoxysilane group is a polymer comprising at least one group, preferably at least two groups, of formula (I):

—Si(R⁴)ₚ(OR⁵)₃₋ₚ (I)
in which:
   each R⁴ independently represents a linear or branched alkyl radical comprising from 1 to 4 carbon atoms;
   each R⁵ independently represents a linear or branched alkyl radical comprising from 1 to 10 carbon atoms and optionally comprising one or more heteroatoms chosen from oxygen and nitrogen, or two OR⁵ groups are involved in one and the same ring comprising from 2 to 8 carbon atoms;
   p is an integer equal to 0, 1 or 2, preferably equal to 0 or 1.

The silylated polymer as defined above comprises at least one crosslinkable alkoxysilane group. The crosslinkable alkoxysilane group is preferably positioned at the end of said polymer. However, positioning in the middle of the chain is not excluded. The silylated polymer is not crosslinked before the application of the adhesive composition. The adhesive composition is applied under conditions which make possible its crosslinking, particularly by condensation of hydrolyzed alkoxysilane (silanol) groups to form siloxane (—Si—O—Si—) bonds.

The silylated polymer (A) is generally provided in the form of a more or less viscous liquid. Preferably, the silylated polymer exhibits a viscosity ranging from 10 to 200 Pa·s, preferably ranging from 20 to 175 Pa·s, said viscosity being measured, for example, according to a method of Brookfield type at 23° C. and 50% relative humidity (S28 spindle).

The silylated polymer (A) preferably comprises two groups of formula (I) but it can also comprise from three to six groups of formula (I).

Preferably, the silylated polymer(s) (A) exhibit a number-average molar mass (Mn) ranging from 500 to 50 000 g/mol, more preferably ranging from 700 to 20 000 g/mol. The number-average molar mass (Mn) of the polymers can be measured by methods well known to a person skilled in the art, for example by size exclusion chromatography using standards of polystyrene type.

According to one embodiment of the invention, the silylated polymer (A) corresponds to one of the formulae (II), (III) and (IV):

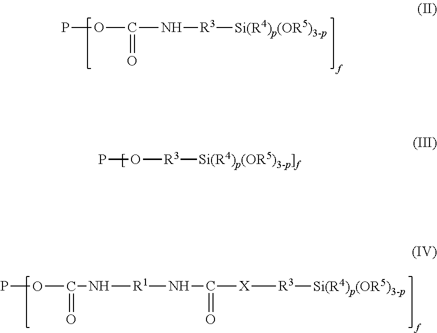

in which:
   R⁴, R⁵ and p have the same meaning as in the formula (I) described above,
   P represents a saturated or unsaturated, linear or branched, polymeric radical optionally comprising one or more heteroatoms, such as oxygen, nitrogen, sulfur or silicon, and preferably exhibiting a number-average molar mass ranging from 100 g/mol to 48 600 g/mol, more particularly from 300 g/mol to 18 600 g/mol or also from 500 g/mol to 12 600 g/mol,
   R¹ represents a divalent hydrocarbon radical comprising from 5 to 15 carbon atoms which can be aromatic or linear or branched aliphatic or cycloaliphatic,
   R³ represents a linear or branched divalent alkylene radical comprising from 1 to 6 carbon atoms, preferably from 1 to 3 carbon atoms,
   X represents a divalent radical chosen from —NH—, —NR⁷—, —O— or —S—,
   R⁷ represents a linear or branched alkyl radical comprising from 1 to 20 carbon atoms and which can also comprise one or more heteroatoms,
   f is an integer ranging from 1 to 6, preferably ranging from 2 to 5, preferably ranging from 2 to 4, more preferably ranging from 2 to 3.

Preferably, in the formulae (II), (III) and/or (IV) above, P represents a polymeric radical chosen in a nonlimiting way from polyethers, polycarbonates, polyesters, polyolefins, polyacrylates, polyamides, polyether polyurethanes, polyester polyurethanes, polyolefin polyurethanes, polyacrylate polyurethanes, polycarbonate polyurethanes, block polyether/polyester polyurethanes, or from polyethers, polycarbonates, polyesters, polyolefins, polyacrylates, polyether polyurethanes, polyester polyurethanes, polyolefin polyurethanes, polyacrylate polyurethanes, polycarbonate polyurethanes, block polyether/polyester polyurethanes, in particular from polyethers, polycarbonates, polyesters, polyacrylates, polyether polyurethanes, polyester polyurethanes, polyacrylate polyurethanes, polycarbonate polyurethanes and block polyether/polyester polyurethanes, for example from polyethers and polyether polyurethanes.

For example, the silylated polymers can be according to the teaching of the document EP 2 468 783, which describes silylated polymers of formula (II) in which P represents a polymeric radical having polyurethane/polyester/polyether blocks.

According to one embodiment, the silylated polymers are chosen from silylated polyurethanes, silylated polyethers and their mixtures.

According to a particular embodiment, the silylated polymer corresponds to one of the formulae (II′), (III′) and (IV′):

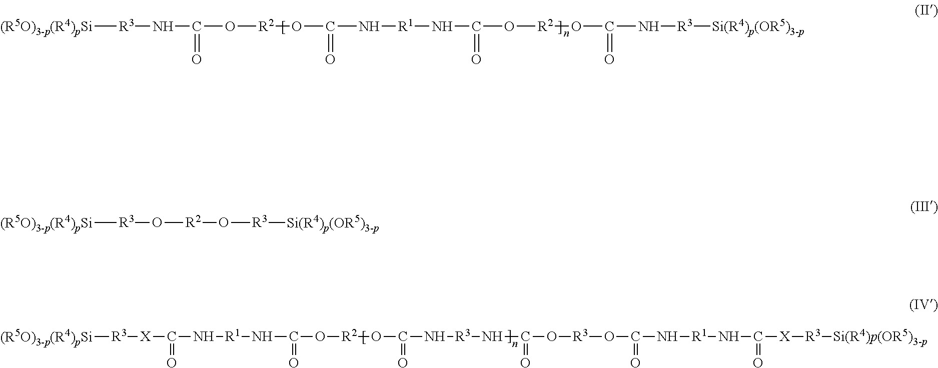

In the formulae (II′), (III′) and (IV′):
R¹, R³, R⁴, R⁵, X, R⁷ and p have the same meaning as in the formulae (II), (III) and (IV) described above,
R² represents a saturated or unsaturated, linear or branched, divalent hydrocarbon radical optionally comprising one or more heteroatoms, such as oxygen, nitrogen, sulfur or silicon, and preferably exhibiting a number-average molar mass ranging from 100 g/mol to 48 600 g/mol, more particularly from 300 g/mol to 18 600 g/mol or also from 500 g/mol to 12 600 g/mol,
n is an integer of greater than or equal to 0.

In the silylated polymers of formulae (II′), (III′) and (IV′) defined above, when the R² radical comprises one or more heteroatoms, said heteroatom(s) are not present at the chain end. In other words, the free valencies of the divalent R² radical bonded to the neighboring oxygen atoms of the silylated polymer each originate from a carbon atom. Thus, the main chain of the R² radical is terminated by a carbon atom at each of the two ends, said carbon atom then exhibiting a free valency.

According to one embodiment, the silylated polymers (A) are obtained from polyols chosen from polyether polyols, polyester polyols, polycarbonate polyols, polyacrylate polyols, polyamide polyols, polysiloxane polyols and polyolefin polyols and their mixtures, or from polyether polyols, polyester polyols, polycarbonate polyols, polyacrylate polyols, polysiloxane polyols and polyolefin polyols and their mixtures, and more preferably from diols chosen from polyether diols, polyester diols, polycarbonate diols, polyacrylate diols, polysiloxane diols, polyolefin diols and their mixtures, in particular from polyether diols, polyester diols, polycarbonate diols, polyacrylate diols, polysiloxane diols and their mixtures. In the case of the polymers of formulae (II′), (III′) and (IV′) described above, such diols can be represented by the formula HO—R²—OH where R² has the same meaning as in the formulae (II′), (III′) and (IV′).

For example, among the radicals of R² type which can be present in the formulae (II′), (III′) and (IV′), mention may be made of the following divalent radicals, the formulae of which below show the two free valencies:
derivative of a polypropylene glycol:

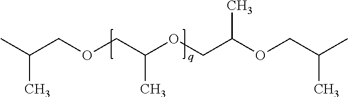

derivative of a polyester diol:

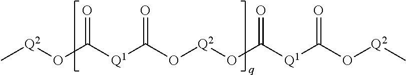

derivative of a polybutadiene diol:

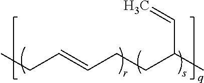

derivative of a polyacrylate diol:

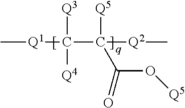

derivative of a polysiloxane diol:

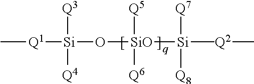

in which:
q represents an integer such that the number-average molecular weight of the R² radical ranges from 100 g/mol to 48 600 g/mol, preferably from 300 g/mol to 18 600 g/mol, more preferably from 500 g/mol to 12 600 g/mol, r and s represent zero or a nonzero integer such that the number-average molecular weight of the R² radical ranges from 100 g/mol to 48 600 g/mol, preferably from 300 g/mol to 18 600 g/mol, more preferably from 500 g/mol to 12 600 g/mol, it being understood that the sum r+s is other than zero,
Q¹ represents a saturated or unsaturated, linear or branched, aromatic or aliphatic, divalent alkylene radical preferably exhibiting from 1 to 18 carbon atoms, more preferably from 1 to 8 carbon atoms,
Q² represents a linear or branched divalent alkylene radical preferably exhibiting from 2 to 36 carbon atoms, more preferably from 1 to 8 carbon atoms,
Q³, Q⁴, Q⁵, Q⁶, Q⁷ and Q⁸ represent, independently of one another, a hydrogen atom or an alkyl, alkenyl or aromatic radical preferably exhibiting from 1 to 12 carbon atoms, preferably from 2 to 12 carbon atoms, more preferably from 2 to 8 carbon atoms.

According to one embodiment, R¹ is chosen from one of the following divalent radicals, the formulae of which below show the two free valencies:
a) the divalent radical derived from isophorone diisocyanate (IPDI):

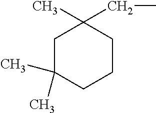

b) the divalent radical derived from dicyclohexylmethane diisocyanate (H12MDI):

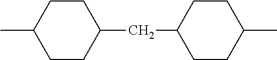

c) the divalent radical derived from toluene diisocyanate (TDI):

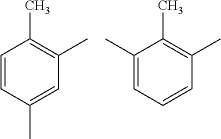

d) the divalent radicals derived from the 4,4′- and 2,4′-isomers of diphenylmethane diisocyanate (MDI):

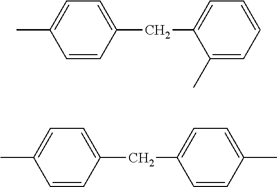

e) the divalent radical derived from hexamethylene diisocyanate (HDI): —(CH₂)₆—
f) the divalent radical derived from m-xylylene diisocyanate (m-XDI):

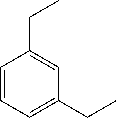

g) the divalent radical derived from pentamethylene diisocyanate (PDI): —(CH₂)₅—

The polymers of formula (II) and (II′) can be obtained according to a process described in the documents EP 2 336 208 and WO 2009/106699. A person skilled in the art will know how to adapt the manufacturing process described in these two documents in the case of the use of different types of polyols. Mention may be made, among the polymers corresponding to the formula (II), of the following commercial references:
Geniosil® STP-E10 (available from Wacker): polyether comprising two groups (I) of dimethoxy type (n equal to 0, p equal to 1 and R⁴ and R⁵ represent a methyl group) exhibiting a number-average molar mass of 8889 g/mol where R³ represents a methyl group;
Geniosil® STP-E30 (available from Wacker): polyether comprising two groups (I) of dimethoxy type (n equal to 0, p equal to 1 and R⁴ and R⁵ represent a methyl group) exhibiting a number-average molar mass of 14493 g/mol where R³ represents a methyl group;
Desmoseal® S XP 2636 (available from Bayer): polyurethane comprising two groups (I) of trimethoxy type (n other than 0, p equal to 0 and R⁵ represents a methyl group) exhibiting a number-average molar mass of 15 038 g/mol where R³ represents an n-propylene group.

The polymers of formula (III) or (III′) can be obtained by hydrosilylation of polyether diallyl ether according to a process described, for example, in the document EP 1 829 928. Mention may be made, among the polymers corresponding to the formula (III), of the following commercial references:
the polymer MS SAX@ 350 (available from Kaneka) corresponding to a polyether comprising two groups (I) of dimethoxy type (p equal to 1 and R⁴ and R⁵ represent a methyl group) having a number-average molar mass ranging from 14 000 to 16 000 g/mol;
the polymer MS SAX@ 260 (available from Kaneka) corresponding to a polyether comprising two groups (1) of dimethoxy type (p equal to 1, R⁴ and R⁵ represent a methyl group) exhibiting a number-average molar mass of 16 000 to 18 000 g/mol where R³ represents an ethyl group;
the polymer MS S303H (available from Kaneka) corresponding to a polyether comprising two groups (1) of dimethoxy type (p is equal to 1 and R⁴ represents a methyl group) having a number-average molecular weight of approximately 22 000 g/mol.

The polymers of formula (IV) or (IV′) can, for example, be obtained by reaction of polyol(s) with one or more diisocyanate(s) followed by a reaction with aminosilanes or mercaptosilanes. A process for the preparation of polymers of formula (IV) or (IV′) is described in the document EP 2 583 988. A person skilled in the art will know how to adapt the manufacturing process described in this document in the case of the use of different types of polyols.

Mention may be made, among the polymers corresponding to the formula (IV), of:
SPUR+® 1050MM (available from Momentive): polyurethane comprising two groups (1) of trimethoxy type (n other than 0, p equal to 0 and R⁵ represents a methyl group) exhibiting a number-average molar mass of 16 393 g/mol where R³ represents an n-propyl group;
SPUR+® Y-19116 (available from Momentive): polyurethane comprising two groups (1) of trimethoxy type (n other than 0 and R⁵ represents a methyl group) exhibiting a number-average molar mass ranging from 15 000 to 17 000 g/mol where R³ represents an n-propyl group.

According to a preferred embodiment of the invention, the adhesive composition comprises at least one silylated polymer of formula (II) and/or (II′) or at least one silylated polymer of formula (III) and/or (III′).

According to a very particularly preferred embodiment of the invention, the adhesive composition comprises at least one silylated polymer of formula (III′), in particular in which R² is a divalent radical derived from a polyether, preferably from a poly(oxyalkylene) diol and more particularly still from a polypropylene glycol. The crosslinking time of said adhesive composition is then lowered entirely advantageously.

The silylated polymer(s) (A) can represent at least 5% by weight, preferably at least 10% by weight, more preferably at least 15% by weight, of the total weight of the adhesive composition. Generally, the content of silylated polymer(s) in the adhesive composition is preferably less than or equal to 90% by weight, more preferably less than or equal to 80% by weight, more preferentially still less than or equal to 70% by weight, advantageously less than or equal to 60% by weight, with respect to the total weight of the adhesive composition.

The amount of silylated polymers (A) in the adhesive composition can depend on the use of said adhesive composition. Specifically, for a mastic composition, the adhesive composition will preferably comprise from 5% to 50% by weight of silylated polymers, preferably from 10% to 40% by weight of silylated polymers, with respect to the total weight of the adhesive composition.

For an adhesive composition used for the formulation of pressure-sensitive self-adhesive articles (of PSA type), the adhesive composition will preferably comprise from 10% to 99.9% by weight, preferably from 15% to 90% by weight, more preferably from 20% to 80% by weight, of silylated polymers, with respect to the total weight of the adhesive composition.

Catalyst (B) The catalyst (B) makes it possible to crosslink the silylated polymer (A), in particular by condensation of hydrolyzed alkoxysilane (silanol) groups to form siloxane (—Si—O—Si—) bonds. The catalyst (B), as defined in the present invention, is stable, in particular during the storage of the adhesive composition.

During the storage of the adhesive composition, the silylated polymer (A) is in crosslinkable (noncrosslinked) form. The crosslinking of the silylated polymer (A) takes place during the application of the adhesive composition to a surface, in particular in the presence of atmospheric moisture (making possible the hydrolysis of alkoxysilane groups), to provide adhesive bonding or also to form a coating or a leaktight seal. The stability of the catalyst (B) advantageously corresponds to maintenance of the crosslinking time of the adhesive composition, after the storage of the latter.

The catalyst (B) has the formula (V):

B(OH)R′R″ (V)
in which:
   R′ represents a substituted or unsubstituted aryl group; and
   R″ is chosen from an OH group and a substituted or unsubstituted aryl group.

Said aryl groups may or may not be substituted. They can, for example, comprise from 6 to 110 carbon atoms. In the case where the R″ group is an aryl group, the R′ and R″ groups can be linked by a biradical (in addition to being linked via the B atom). They thus form an additional intermediate ring as illustrated, for example, in the formula (Vc) described below. The term “biradical” is understood to mean a group which is bonded to other groups (in the case in point bonded to R′, on the one hand, and R″, on the other hand) by two chemical bonds. This biradical can in particular be chosen from oxygen (—O—) and sulfur (—S—).

According to some embodiments, the catalyst (B) is a boronic acid of formula (Va):

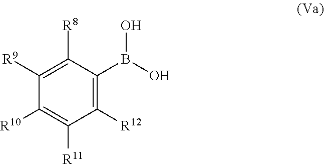

in which:
   R⁸, R⁹, R¹⁰, R¹¹ and R¹² represent, independently of one another, a hydrogen atom, a halogen atom or a linear or branched alkyl group comprising from 1 to 20 carbon atoms and which can comprise at least one heteroatom.

The heteroatom is preferably a halogen atom, preferably chosen from fluorine, chlorine and bromine.

According to other embodiments, the catalyst (B) is a borinic acid of formula (Vb) or (Vc):

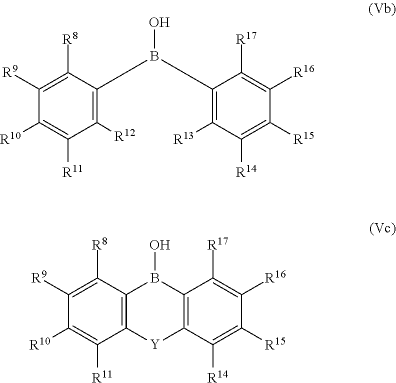

in which:
   R⁸, R⁹, R¹⁰, R¹¹ and R¹² are as described in detail above;
   R¹³, R¹⁴, R¹⁵, R¹⁶ and R¹⁷ represent, independently of one another, a hydrogen atom, a halogen atom or a linear or branched alkyl group comprising from 1 to 20 carbon atoms and which can comprise at least one heteroatom, and
   Y is an oxygen or sulfur atom.

The heteroatom is preferably a halogen atom, preferably chosen from fluorine, chlorine and bromine.

The R⁸, R⁹, R¹⁰, R¹¹, R¹², R¹³, R¹⁴, R¹⁵, R¹⁶ and R¹⁷ group(s) can be independently chosen from a hydrogen atom, a linear or branched alkyl group comprising from 1 to 20 carbon atoms, preferably from 1 to 5 carbon atoms, a linear or branched fluoroalkyl group comprising from 1 to 20 carbon atoms and preferably from 1 to 5 carbon atoms, a cycloalkyl group comprising from 1 to 20 carbon atoms and preferably from 1 to 5 carbon atoms, and a halogen. Preferably, the above group(s) are chosen from a fluoroalkyl group (preferably a —CF₃ group), a halogen, and also their combinations.

According to some embodiments, the R⁸, R⁹, R¹⁰, R¹¹ and R¹² groups, and optionally (that is to say, when the catalyst has the formula (Vb) or (Vc)) the R¹³, R¹⁴, R¹⁵, R¹⁶ and R¹⁷ groups, are all hydrogen atoms.

According to other preferred embodiments, the R⁸, R¹², R¹³ and R¹⁷ groups are hydrogen atoms and at least one of the R⁹, R¹⁰, R¹¹, R¹⁴, R¹⁵ and/or R¹⁶ groups is an alkyl (preferably fluoroalkyl) group. Preferably, each aryl group (of the catalyst of formula (Vb) or (Vc)) has from 1 to 3 groups other than hydrogen.

According to preferred embodiments, one or more of the R⁸, R⁹, R¹⁰, R¹¹, R¹², R¹³, R¹⁴, R¹⁵, R¹⁶ and R¹⁷ groups can comprise at least one atom chosen from fluorine, chlorine and bromine.

According to some preferred embodiments, one, preferably two and more preferably three of the R⁸, R⁹, R¹⁰, R¹¹, R¹², R¹³, R¹⁴, R¹⁵, R¹⁶ and R¹⁷ groups are chosen from a fluorine atom and a fluoroalkyl group comprising from 1 to 20 carbon atoms, preferably from 1 to 5 carbon atoms and more preferably a —CF₃ group.

In the case where the catalyst (B) has the formula (Va) or (Vb) and when one of the R⁸, R⁹, R¹⁰, R¹¹ and R¹² groups and optionally one of the R¹³, R¹⁴, R¹⁵, R¹⁶ and R¹⁷ groups is other than a hydrogen atom, this group can be chosen from a fluorine atom and a fluoroalkyl group comprising from 1 to 20 carbon atoms, preferably from 1 to 5 carbon atoms and more preferably a —CF₃ group. Preferably, this group is one of the R⁹, R¹⁰, R¹¹ groups and/or one of the R¹⁴, R¹⁵, R¹⁶ groups.

In the case where the catalyst (B) has the formula (Va) or (Vb) and when two of the R⁸, R⁹, R¹⁰, R¹¹ and R¹² groups and optionally two of the R¹³, R¹⁴, R¹⁵, R¹⁶ and R¹⁷ groups are other than a hydrogen atom, these groups can be chosen from a fluorine atom and a fluoroalkyl group comprising from 1 to 20 carbon atoms, preferably from 1 to 5 carbon atoms and more preferably a —CF₃ group. It is preferable for these groups to be the R⁹ and R¹¹ groups and optionally the R¹⁴ and R¹⁶ groups.

In the case where the catalyst (B) has the formula (Vc) and when one of the R⁸, R⁹, R¹⁰ and R¹¹ groups and one of the R¹³, R¹⁴, R¹⁵ and R¹⁶ groups is other than a hydrogen atom, this substituent can be chosen from a fluorine atom and a fluoroalkyl group comprising from 1 to 20 carbon atoms, preferably from 1 to 5 carbon atoms and more preferably a —CF₃ group. Preferably, this group is one of the R⁹, R¹⁰, R¹¹ groups and optionally one of the R¹⁴, R¹⁵, R¹⁶ groups.

In the case where the catalyst (B) has the formula (Vc) and when two of the R⁸, R⁹, R¹⁰ and R¹¹ groups and two of the R¹³, R¹⁴, R¹⁵ and R¹⁶ groups are other than a hydrogen atom, preferably chosen from a fluorine atom and a fluoroalkyl group comprising from 1 to 20 carbon atoms, more preferably from 1 to 5 carbon atoms and more preferably a —CF₃ group, it is preferable for these groups to be the R⁹ and R¹¹ groups and the R¹⁴ and R¹⁶ groups.

Advantageously, the catalyst (B) is a borinic acid of formula (Vb) as described above, including the embodiments and preferred characteristics.

According to some preferred embodiments, the catalyst (B) has one of the following formulae (VI) to (XX):

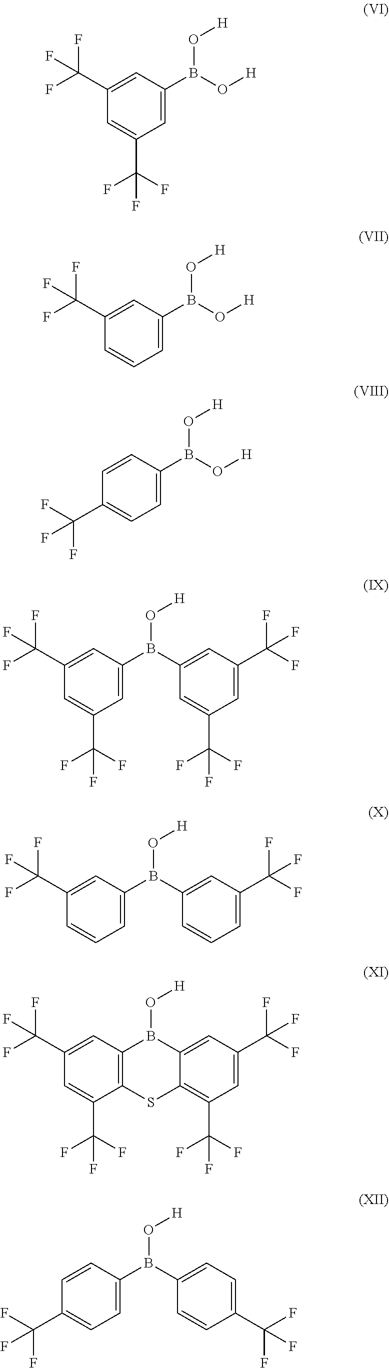

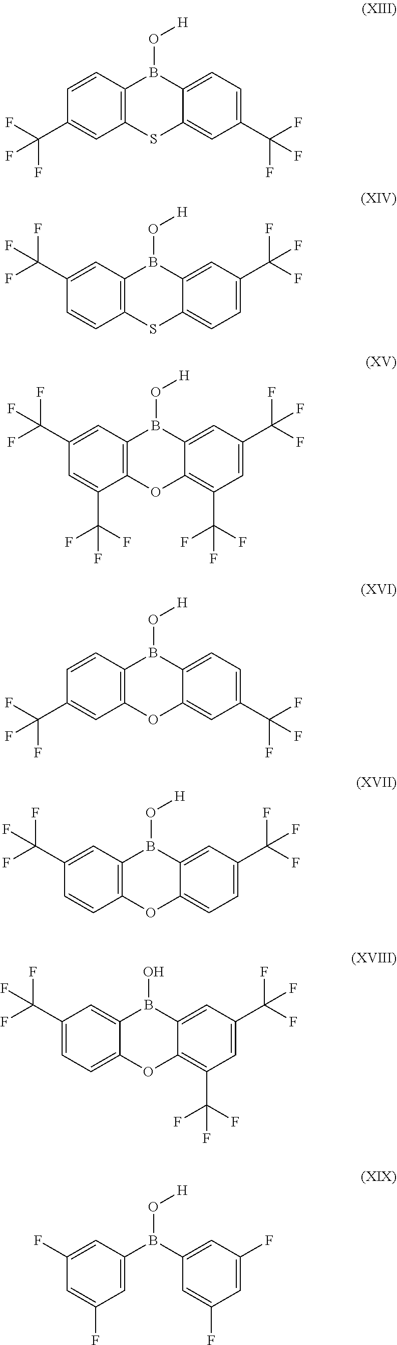

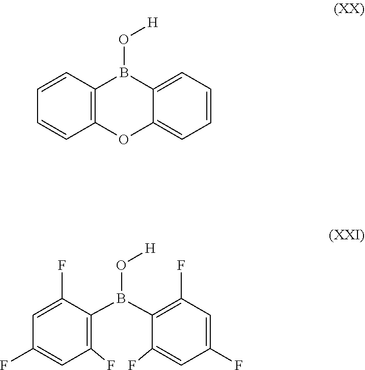 [SMILES: OB1c2ccccc2Oc2ccccc21 ; OB(c1c(F)cc(F)cc1F)c1c(F)cc(F)cc1F]

Advantageously, the catalyst (B) has one of the formulae (VI), (VIII), (IX), (X), (XII), (XIX), (XX) or (XXI), for example (IX), (X), (XII), (XIX) or (XXI), in particular (IX) or (XXI), the formulae being as described above.

According to some embodiments, the catalyst (B) can be present at a content of from 0.05% to 10% by weight and preferably from 0.5% to 5% by weight, with respect to the weight of the silylated polymer (A). This content can be from 0.05% to 0.1%; or from 0.1% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%, by weight, with respect to the weight of the silylated polymer (A).

### Adhesive Composition

According to some embodiments, the adhesive composition according to the invention is composed essentially, indeed even consists, of the silylated polymer (A) and the catalyst (B).

The term “is composed essentially” is understood to mean that the adhesive composition according to the invention comprises a content of ingredients other than the silylated polymer (A) and the catalyst (B) of less than 5% by weight, with respect to the total weight of said composition, preferably of less than 2% by weight, more preferentially of less than or equal to 1% by weight.

Alternatively, the adhesive composition according to the invention can also comprise one or more other additive(s).

The term “other additives” is understood to mean additives which are neither silylated polymers (A) nor catalysts (B) as defined above.

Mention may be made, among the other additives, of fillers, adhesion promoters, plasticizers, rheological agents, moisture absorbers, UV and heat stabilizers, cocatalysts (different from the catalyst (B) defined in the present invention).

The adhesive composition according to the invention can additionally comprise at least one crosslinker, other than the catalyst (B). The crosslinker can be chosen from silicates having, for example, one or more hydrolyzable groups; preferably, the crosslinker is tetraethyl orthosilicate (TEOS). The use of a crosslinker can make it possible to improve the crosslinking rate in some cases.

The adhesive composition according to the invention can additionally comprise at least one cocatalyst, other than the catalyst (B). The cocatalyst can in particular be an aminoalkoxysilane. The presence of the —NH₂ group makes it possible effectively to cocatalyze the hydrolysis and condensation reactions in the presence of moisture. Other examples of cocatalysts are BF₃ complexes (for example BF₃-monoethylamine) which make it possible to facilitate the departure of the alkoxy groups during the hydrolysis and condensation reactions.

The adhesive composition according to the invention can comprise fillers, it being possible for said fillers to be inorganic fillers, organic fillers or a mixture of inorganic and organic fillers.

The inorganic fillers can be chosen from calcium carbonates, calcium polycarbonates, aluminum hydroxide, talcs, kaolins, carbon black, silicas and fumed silica, quartz or glass beads.

The organic fillers can be chosen from polyvinyl chloride, polyethylene, polyamide, styrene/butadiene resins or any other organic polymer in the powder form.

Preferably, the fillers exhibit a particle size ranging from 0.010 to 20 μm, preferably ranging from 0.020 to 15 μm, more preferably ranging from 0.030 to 5 μm.

The fillers present in the adhesive composition can provide various functions within the composition, for example a rheological agent function.

The fillers can represent up to 80% by weight, preferably from 20% to 70% by weight, more preferably from 30% to 60% by weight, of the total weight of the adhesive composition.

Additives can be provided in order to adjust the rheology of the adhesive composition according to the applicational constraints. For example, an additive which increases the yield point (rheological agent) can be added in order to prevent sagging during the application of the composition, in particular when the surface receiving the layer of adhesive composition is not horizontal.

The rheological agent(s) can represent from 0.01% to 8% by weight, preferably from 0.05% to 6% by weight, preferably from 0.1% to 5% by weight, of the total weight of the adhesive composition.

The plasticizer can, for example, be chosen from esters of benzoic acid, phthalic acid, trimellitic acid, pyromellitic acid, adipic acid, sebacic acid, fumaric acid, maleic acid, itaconic acid or citric acid or from derivatives of polyester, of polyether, hydrocarbon mineral oil. Mention may be made, among derivatives of phthalic acid, of phthalates, such as dibutyl phthalate, dioctyl phthalate, dicyclohexyl phthalate, diisooctyl phthalate, diisodecyl phthalate, dibenzyl phthalate or butyl benzyl phthalate. If the plasticizer is present, it is preferably chosen from phthalates, sebacates, adipates and benzoates.

The plasticizer must be compatible with the polymer and must not demix in the adhesive composition. The plasticizer makes it possible to increase the plasticity (elongation) of the composition and to reduce its viscosity.

When a plasticizer is present in the composition, its content is preferably less than or equal to 30% by weight, preferably less than or equal to 20% by weight and more preferably from 10% to 15% by weight, expressed with respect to the total weight of the adhesive composition. When it is present, the plasticizer represents from 10% to 30% by weight or preferably from 10% to 20% by weight of the total weight of the adhesive composition.

The moisture absorber, if it is present, can be chosen from vinyltrimethoxysilane (VTMO), such as Silquest® A171, available from Momentive, vinyltriethoxysilane (VTEO), such as Geniosil® GF 56, available from Wacker, or alkoxyarylsilanes, such as Geniosil® XL 70, available from Wacker.

The moisture absorber makes it possible, in addition to the neutralization of the water possibly present in the adhesive composition, for example via the additives, to slightly increase the crosslinking time of the adhesive composition when it would be too rapid, according to the targeted applications.

When a moisture absorber is present in the composition, its content is preferably less than or equal to 3% by weight, more preferably less than or equal to 2% by weight, expressed with respect to the total weight of the adhesive composition. When it is present, the moisture absorber is present at a content of from 0.5% to 3% by weight and preferably from 1% to 2% by weight of the total weight of the adhesive composition. If it is present in an excessively large amount, the moisture absorber can bring about an increase in the crosslinking time of the adhesive composition.

UV and heat stabilizers can be added in order to prevent (slow down or stop) degradation of the polymer for a better resistance to UV radiation or to thermal shocks. Mention will be made, by way of examples, of Tinuvin® 123, Tinuvin® 326 or Irganox® 245, which are available from BASF.

Mention may be made, as examples of adhesion promoter, of aminosilanes and glycidoxysilanes. In particular, aminosilanes make it possible to improve the crosslinking of silylated polymers of formula (II) or (II′) or (IV) or (IV′). In the case of silylated polymer of formula (III) or (III′), it will be preferable for the adhesive composition not to comprise aminosilanes.

When an adhesion promoter is present in the composition, its content advantageously ranges from 0.1% to 5% by weight, preferably from 0.2% to 3% by weight, more preferentially from 0.5% to 2% by weight, with respect to the total weight of the adhesive composition.

Preferably, the adhesive composition according to the invention exhibits a viscosity ranging from 10 000 to 500 000 MPa·s, measured at 23° C. using a conventional rheometer, taking a Bingham model.

According to some embodiments, the adhesive composition according to the invention is provided in a two-component form in which the silylated polymer (A) and the catalyst (B) are packaged in two separate compartments. In the case where the adhesive composition comprises additives, these additives can be present in the compartment (part) comprising the silylated polymer (A) and/or in the compartment (part) comprising the catalyst (B). According to this embodiment, the compartment comprising the catalyst (B) can optionally comprise water, preferably in an amount ranging from 0.1% to 10% by weight, with respect to the total weight of the adhesive composition according to the invention.

The adhesive composition is not crosslinked before it is used, for example by application to a support. The adhesive composition according to the invention is applied under conditions which make possible its crosslinking. The crosslinking of the adhesive composition has the effect of creating, between the polymeric chains of the silylated polymer described above and under the action of atmospheric moisture, bonds of siloxane type which result in the formation of a three-dimensional polymeric network.

The adhesive composition according to the invention can be prepared by mixing the silylated polymer(s) (A) and the catalyst(s) (B) before application of the composition to a substrate, for example at a temperature ranging from 10° C. to 120° C. and at a relative humidity ranging from 20% to 55% (+/−5%). When fillers are present in the adhesive composition, the catalyst(s) (B) are preferably added in a second stage, after the mixing of the silylated polymer(s) and of the fillers. The other optional additives are introduced in accordance with the normal usages.

Alternatively, one of the two parts (silylated polymer (A) and catalyst (B)) of the composition can be coated at the surface of a substrate in a first step and, in a second step, the second of the two parts can be coated at the surface of the substrate on top of the first of the two parts. In this case, the crosslinking of the composition is carried out on the surface of the substrate, for example at a temperature ranging from 10° C. to 120° C. and at a relative humidity ranging from 20% to 55% (+/−5%).

The adhesive composition according to the invention can be packaged in a kit comprising at least two separate compartments and comprising the adhesive composition according to the invention.

Said kit can comprise water, it being understood that, in this case, the water and the silylated polymer(s) are packaged in two separate compartments.

Thus, in such a kit, the adhesive composition according to the invention can be provided in a two-component form in which the silylated polymer (A) and the catalyst (B) are packaged in two separate compartments (parts). According to this embodiment, the kit can additionally comprise water, either in the compartment comprising the catalyst (B) or in a third compartment. In the case where the water is present in the compartment comprising the catalyst (B), then the water can represent from 0.1% to 10% by weight, with respect to the total weight of the adhesive composition according to the invention.

In this case, the ratio by weight of the part A (comprising the silylated polymer (A)) of the composition to the part B (comprising the catalyst (B)) can be from 100/1 to 0.2/1, in particular from 50/1 to 0.5/1 and preferably from 40/1 to 1/1. For example, this ratio can be from 40/1 to 35/1; or from 35/1 to 30/1; or from 30/1 to 25/1; or from 25/1 to 20/1; or from 20/1 to 15/1; or from 15/1 to 10/1; or from 10/1 to 5/1; or from 5/1 to 1/1.

According to other preferred embodiments, the adhesive composition is in a one-component form, that is to say that, before use of the composition, the silylated polymer (A) and the catalyst (B) are packaged in the same compartment. In this case, water can be stored in a second compartment. Thus, during the application of the adhesive composition, the constituents of the compartments of the kit according to the invention are mixed in order to make possible the crosslinking of the silylated polymer(s).

The present invention also relates to an adhesive bonding process comprising the application of the adhesive composition according to the invention to a surface, followed by the crosslinking of said adhesive composition, in particular by condensation of hydrolyzed alkoxysilane (silanol) groups to form siloxane (—Si—O—Si—) bonds.

The crosslinking of the adhesive composition is promoted by moisture, in particular by atmospheric moisture.

The adhesive composition can be crosslinked at a temperature of from 15 to 120° C., and preferably at a temperature of from 20 to 65° C. For example, this temperature can be from 15 to 20° C.; or from 20 to 25° C.; or from 25 to 30° C.; or from 30 to 35° C.; or from 35 to 40° C.; or from 40 to 45° C.; or from 45 to 50° C.; or from 50 to 55° C.; or from 55 to 60° C.; or from 60 to 65° C.; or from 65 to 70° C.; or from 70 to 75° C.; or from 75 to 80° C.; or from 80 to 85° C.; or from 85 to 90° C.; or from 90 to 95° C.; or from 95 to 100° C.; or from 100 to 105° C.; or from 105 to 110° C.; or from 110 to 115° C.; or from 115 to 120° C.

According to some embodiments, the crosslinking of the adhesive composition is carried out in the presence of water.

According to other embodiments, the crosslinking of the adhesive composition is carried out in the absence of water (other than atmospheric moisture).

The adhesive composition according to the invention can be applied to any type of substrate, such as concrete, tiles, metal, glass, wood and plastics.

The adhesive composition can form a continuous layer on the surface of the substrate. This layer can have a thickness of from 1 μm to 2 mm and preferably from 25 μm to 2 mm.

The composition according to the invention can be used as an adhesive composition, so as to adhesively bond two substrates together. Thus, after crosslinking, the composition can form an adhesive layer keeping two substrates fixed together. More particularly, after coating of the adhesive composition on the surface of a substrate, the surface of an additional substrate can be brought into contact with the coated surface, so as to adhesively bond the two substrates. According to certain embodiments, bringing the additional substrate into contact with the coated surface, the assembly can be placed under a hot press so as to accelerate the adhesive bonding of the two substrates together. The temperature of this press can, for example, be from 60 to 110° C. and preferably from 80 to 100° C.

According to other embodiments, the adhesive composition according to the invention can be used as coating on the surface of a substrate. Thus, after crosslinking, the composition can form a layer covering the surface of the substrate in order for example to modify one or more properties of its surface.

Thus, the articles manufactured after application of the composition according to the invention comprise at least one surface coated with the adhesive composition.

When the adhesive composition is used as coating, it is an external surface of the article which is concerned.

When the adhesive composition is used as adhesive, it is an internal surface of the article which is concerned, that is to say a surface of the article which is in contact with, for example, another surface of the article, and the composition is found between these two surfaces.

### EXAMPLES

The following examples illustrate the invention without limiting it.

The following compounds were used in the context of the examples:
A1: silylated polymer MS S303H from Kaneka;

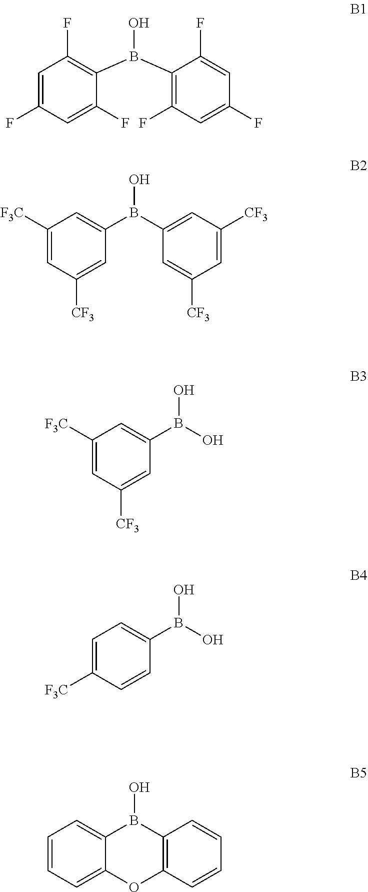 [SMILES: OB(c1c(F)cc(F)cc1F)c1c(F)cc(F)cc1F ; OB(c1cc(C(F)(F)F)cc(C(F)(F)F)c1)c1cc(C(F)(F)F)cc(C(F)(F)F)c1 ; OB(O)c1cc(C(F)(F)F)cc(C(F)(F)F)c1 ; OB(O)c1ccc(C(F)(F)F)cc1 ; OB1c2ccccc2Oc2ccccc21]

Cat1: dibutyltin bis(acetylacetonate) from TIB Chemicals (TIB KAT 226).

### Example 1

First, the adhesive compositions C1 to C5 (according to the invention) were prepared by bringing the silylated polymer A1 into contact with the catalysts B1 to B5 (1% by weight, with respect to the weight of the silylated polymer) in the presence of water (1% by weight, with respect to the weight of the silylated polymer), as indicated in table 1 below. The reaction was carried out at a temperature of 50° C. and under air. The composition Comp1 (comparative example), in which the silylated polymer A1 was brought into contact with the tin catalyst, was prepared under the same conditions.

TABLE 1

| | | | Water | Crosslinking |
|---|---|---|---|---|
| Compositions | A1 (mg) | Catalyst (mg) | (mg) | time (days) |
| C1 | 506 | B1 (5.0) | 5 | 2 |
| C2 | 845 | B2 (8.45) | 8 | 2 |
| C3 | 694 | B3 (6.94) | 7 | 10 |
| C4 | 640 | B4 (6.4) | 6 | 10 |
| C5 | 581 | B5 (5.8) | 6 | 15 |
| Comp1 | 556 | Cat1 (5.5) | 6 | 3 |

The “crosslinking time” corresponds to a skin formation time and is measured by applying a bead of the adhesive composition to a cardboard substrate. The surface of the bead is touched at different times, using a pipette tip made of low-density polyethylene, in order to determine the moment at which the skin is formed at the surface.

It should be noted that no crosslinking is observed when no catalyst is employed (not shown in table 1).

On the other hand, it is found that, with the catalysts according to the invention (devoid of tin), the crosslinking of the silylated polymer is carried out efficiently, with identical amounts of catalysts, and with times which are comparable and acceptable compared with the crosslinking time obtained with the tin catalyst Cat1.

### Example 2

In this example, the compositions C6 to C10 were prepared by bringing the silylated polymer A1 into contact with the catalysts B1 to B5 (1% by weight, with respect to the weight of the silylated polymer) in the absence of water, as indicated in table 2 below. The reaction was carried out at a temperature of 50° C. and under air. The composition Comp2 (comparative example), in which the silylated polymer A1 was brought into contact with the tin catalyst Cat1, was prepared under the same conditions.

TABLE 2

| | | | Crosslinking |
|---|---|---|---|
| Compositions | A1 (mg) | Catalyst (mg) | time (days) |
| C6 | 480 | B1 (4.8) | 2 |
| C7 | 627 | B2 (6.2) | 2 |
| C8 | 757 | B3 (7.57) | 10 |
| C9 | 704 | B4 (7.0) | 10 |
| C10 | 704 | B5 (7.0) | 15 |
| Comp2 | 549 | Cat1 (5.4) | 3 |

The “crosslinking time” is determined in accordance with example 1.

It should be noted that no crosslinking is observed when no catalyst is employed (not shown in table 2).

On the other hand, once again, it is found (even in the absence of water) that, with the catalysts according to the invention (devoid of tin), the crosslinking of the silylated polymer is carried out efficiently, with identical amounts of catalysts, and with times which are comparable and acceptable compared with the crosslinking time obtained with the tin catalyst Cat1.

1-12. (canceled)

13. An adhesive composition comprising:
at least one silylated polymer (A) comprising at least one group of formula (I):
—Si(R⁴)ₚ(OR⁵)₃₋ₚ (I)
in which:
each R⁴ independently represents a linear or branched alkyl radical comprising from 1 to 4 carbon atoms,
each R⁵ independently represents a linear or branched alkyl radical comprising from 1 to 10 carbon atoms and optionally comprising one or more heteroatoms chosen from oxygen and nitrogen, or two OR⁵ groups are involved in one and the same ring comprising from 2 to 8 carbon atoms,
p is an integer equal to 0, 1 or 2,
the silylated polymer (A) corresponding to one of the formulae (II), (III) and (IV): 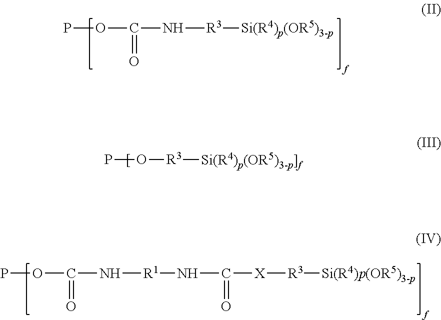
in which:
P represents a saturated or unsaturated, linear or branched, polymeric radical optionally comprising one or more heteroatoms,
R¹ represents a divalent hydrocarbon radical comprising from 5 to 15 carbon atoms, which can be aromatic or linear or branched aliphatic or cycloaliphatic,
R³ represents a linear or branched divalent alkylene radical comprising from 1 to 6 carbon atoms,
X represents a divalent radical chosen from —NH—, —NR⁷—, —O— or —S—,
R⁷ represents a linear or branched alkyl radical comprising from 1 to 20 carbon atoms, and which can also comprise one or more heteroatoms,
f is an integer ranging from 1 to 6; and
at least one catalyst (B) of formula (V):
B(OH)R′R″ (V)
in which:
R′ represents a substituted or unsubstituted aryl group; and
R″ is chosen from an OH group and a substituted or unsubstituted aryl group.

14. The composition as claimed in claim 13, in which the catalyst (B) has one of the following formulae: 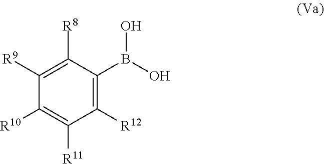
in which R⁸, R⁹, R¹⁰, R¹¹ and R¹² represent, independently of one another, a hydrogen atom, a halogen atom or a linear or branched alkyl group comprising from 1 to 20 carbon atoms, and which can comprise at least one heteroatom; 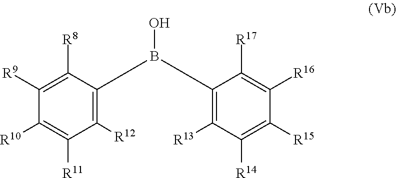
in which:
R⁸, R⁹, R¹⁰, R¹¹ and R¹² are as described in detail above; and
R¹³, R¹⁴, R¹⁵, R¹⁶ and R¹⁷ represent, independently of one another, a hydrogen atom, a halogen atom or a linear or branched alkyl group comprising from 1 to 20 carbon atoms, and which can comprise at least one heteroatom; and 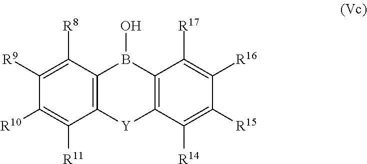
in which:
R⁸, R⁹, R¹⁰, R¹¹, R¹², R¹³, R¹⁴, R¹⁵, R¹⁶ and R¹⁷ are as described in detail above; and
Y is an oxygen or sulfur atom.

15. The composition as claimed in claim 14, in which R⁸, R⁹, R¹⁰, R¹¹, R¹², R¹³, R¹⁴, R¹⁵, R¹⁶ and R¹⁷ are chosen from a hydrogen atom, a linear or branched alkyl group comprising from 1 to 20 carbon atoms, a linear or branched fluoroalkyl group comprising from 1 to 20 carbon atoms, a cycloalkyl group comprising from 1 to 20 carbon atoms, and a halogen.

16. The composition as claimed in claim 14, in which one of the R⁸, R⁹, R¹⁰, R¹¹, R¹², R¹³, R¹⁴, R¹⁵, R¹⁶ and R¹⁷ groups are chosen from a fluorine atom and a fluoroalkyl group comprising from 1 to 20 carbon atoms.

17. The composition as claimed in claim 13, being a one-component composition or a two-component composition.

18. The composition as claimed in claim 13, in which the catalyst is present at a content of from 0.05% to 10% by weight, with respect to the total weight of the silylated polymer.

19. The composition as claimed in claim 13, in which P represents a polymeric radical chosen from polyethers, polycarbonates, polyesters, polyacrylates, polyether polyurethanes, polyester polyurethanes, polyacrylate polyurethanes, polycarbonate polyurethanes and block polyether/polyester polyurethanes.

20. The use of the composition as claimed in claim 13, as adhesive for bonding two substrates together, or as coating on the surface of a substrate.

21. An article comprising at least one layer obtained by crosslinking of the composition as claimed in claim 13.

22. A process for the preparation of the article as claimed in claim 21, comprising the application of the adhesive composition to a surface, followed by the crosslinking of said adhesive composition.

23. A compound for catalyzing crosslinking of a silylated polymer (A), the catalyst compound having a formula (V):
B(OH)R′R″ (V)
in which:
R′ represents a substituted or unsubstituted aryl group; and
R″ is chosen from an OH group and a substituted or unsubstituted aryl group,
the silylated polymer (A) comprising at least one group of formula (I):
—Si(R⁴)ₚ(OR⁵)₃₋ₚ (I)
in which:
each R⁴ independently represents a linear or branched alkyl radical comprising from 1 to 4 carbon atoms,
each R⁵ independently represents a linear or branched alkyl radical comprising from 1 to 10 carbon atoms and optionally comprising one or more heteroatoms chosen from oxygen and nitrogen, or two OR⁵ groups will be involved in one and the same ring comprising from 2 to 8 carbon atoms, and
p is an integer equal to 0, 1 or 2,
the silylated polymer (A) corresponding to one of the formulae (II), (III) and (IV): 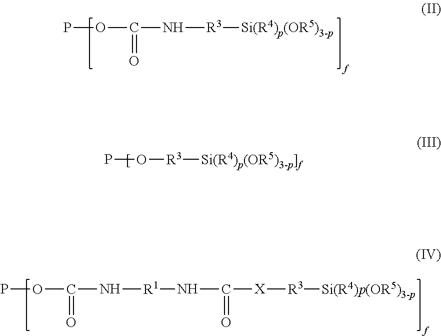
in which:
P represents a saturated or unsaturated, linear or branched, polymeric radical optionally comprising one or more heteroatoms, such as oxygen, nitrogen, sulfur or silicon,
R¹ represents a divalent hydrocarbon radical comprising from 5 to 15 carbon atoms which can be aromatic or linear or branched aliphatic or cycloaliphatic,
R³ represents a linear or branched divalent alkylene radical comprising from 1 to 6 carbon atoms,
X represents a divalent radical chosen from —NH—, —NR⁷—, —O— or —S—,
R⁷ represents a linear or branched alkyl radical comprising from 1 to 20 carbon atoms, and which can also comprise one or more heteroatoms,
f is an integer ranging from 1 to 6.

24. The catalyst compound of claim 23, in which the catalyst compound has one of the following formulae: 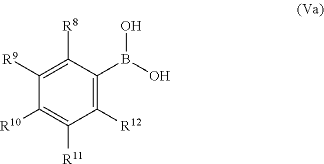
in which R⁸, R⁹, R¹⁰, R¹¹ and R¹² represent, independently of one another, a hydrogen atom, a halogen atom or a linear or branched alkyl group comprising from 1 to 20 carbon atoms, and which can comprise at least one heteroatom; 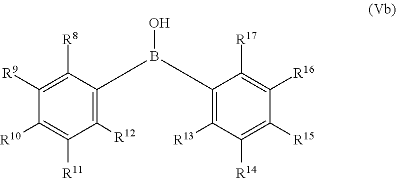
in which:
R⁸, R⁹, R¹⁰, R¹¹ and R¹² are as described in detail above; and
R¹³, R¹⁴, R¹⁵, R¹⁶ and R¹⁷ represent, independently of one another, a hydrogen atom, a halogen atom or a linear or branched alkyl group comprising from 1 to 20 carbon atoms, and which can comprise at least one heteroatom; and 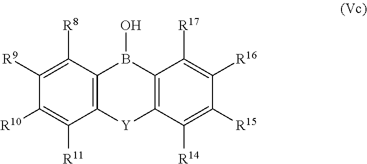
in which:
R⁸, R⁹, R¹⁰, R¹¹, R¹², R¹³, R¹⁴, R¹⁵, R¹⁶ and R¹⁷ are as described in detail above; and
Y is an oxygen or sulfur atom.

25. The composition as claimed in claim 15, in which R⁸, R⁹, R¹⁰, R¹¹, R¹², R¹³, R¹⁴, R¹⁵, R¹⁶ and R¹⁷ are chosen from a hydrogen atom, a linear or branched alkyl group comprising from 1 to 5 carbon atoms, a linear or branched fluoroalkyl group comprising from 1 to 5 carbon atoms, a cycloalkyl group comprising from 1 to 5 carbon atoms, and a halogen.

26. The composition as claimed in claim 25, in which R⁸, R⁹, R¹⁰, R¹¹, R¹², R¹³, R¹⁴, R¹⁵, R¹⁶ and R¹⁷ are chosen from a fluoroalkyl group, a halogen, and also their combinations.
